(19) United States
(12) Patent Application Publication
(10) Pub. No.: US 2012/0151602 A1
(43) Pub. Date: Jun. 14, 2012

(54) Method and Apparatus for Digital Rights Decomposition

(75) Inventors: Wenhui Lu, Tampere (FI); Zheying Zhang, Kangasala (FI); Jyrki Nummenmaa, Tampera (FI)

(73) Assignee: Nokia Corporation

(21) Appl. No.: 12/965,107

(22) Filed: Dec. 10, 2010

(51) Int. Cl. G06F 21/00

(52) U.S. Cl. 726/27

(57) ABSTRACT

Various methods for digital rights decomposition are provided. One example method includes receiving a set of digital rights, and identifying conditions within the set of digital rights that have relationships with more than one permission and create copies of the identified conditions based on the number of relationships an identified condition has with the permissions. The example method also associating each condition with a respective permission based on the relationships to generate fundamental condition-permission components, and constructing a fundamental decomposition of the set of digital rights based on the fundamental condition-permission components. Similar and related example methods, example apparatuses, and example computer program products are also provided.

### TECHNICAL FIELD

Embodiments of the present invention relate generally to digital rights and digital right management (DRM), and, more particularly, relate to a method, apparatus, and computer program product for decomposing digital rights.

### BACKGROUND

With the proliferation of digital media and digital communications, the ability to wrongfully copy, distribute, and otherwise misuse the copyright protected works of others has become readily available to the average individual. In an attempt to protect these works (e.g., media content), digital rights have been established that prevent the misuse of protected materials and content. However, due to a lack of standardization in the formatting of digital rights, users may suffer a poor user experience because the user's device or application may not support a particular digital rights format.

### SUMMARY

Example methods, example apparatuses, and example computer program products are described herein that provide for digital rights decomposition to generate a fundamental decomposition of a set of digital rights. One example embodiment of the present invention is an example method. The example method may comprise receiving a set of digital rights, wherein the set of digital rights includes conditions, permissions, and relationships between the conditions and permissions. The example method may further comprise including the conditions of the set of digital rights in a pool of conditions, identifying conditions that have relationships with more than one permission and create copies of the identified conditions based on the number of relationships an identified condition has with the permissions, including the copies of the conditions in the pool of conditions, associating each condition within the pool of conditions with a respective permission based on the relationships to generate fundamental condition-permission components, and constructing a fundamental decomposition of the set of digital rights based on the fundamental condition-permission components.

An additional example embodiment is an apparatus comprising at least one processor and at least one memory including computer program code, the at least one memory and the computer program code configured to, with the at least one processor, direct the apparatus to perform various functionalities. In this regard, the example apparatus may be directed to receive a set of digital rights, wherein the set of digital rights includes conditions, permissions, and relationships between the conditions and permissions. The example apparatus may be further directed to include the conditions of the set of digital rights in a pool of conditions, identify conditions that have relationships with more than one permission and create copies of the identified conditions based on the number of relationships an identified condition has with the permissions, include the copies of the conditions in the pool of conditions, associate each condition within the pool of conditions with a respective permission based on the relationships to generate fundamental condition-permission components, and construct a fundamental decomposition of the set of digital rights based on the fundamental condition-permission components.

Another example embodiment is a computer program that, when executed causes an apparatus to perform functionality. In this regard, the computer program, when executed may cause an apparatus to receive a set of digital rights, wherein the set of digital rights includes conditions, permissions, and relationships between the conditions and permissions. The example computer program may also be configured to cause the apparatus to include the conditions of the set of digital rights in a pool of conditions, identify conditions that have relationships with more than one permission and create copies of the identified conditions based on the number of relationships an identified condition has with the permissions, include the copies of the conditions in the pool of conditions, associate each condition within the pool of conditions with a respective permission based on the relationships to generate fundamental condition-permission components, and construct a fundamental decomposition of the set of digital rights based on the fundamental condition-permission components.

Another example embodiment is a computer program product comprising a non-transitory memory having computer program code stored thereon, wherein the computer program code is configured to direct an apparatus to perform various functionalities. In this regard, the program code may be configured to direct the apparatus to receive a set of digital rights, wherein the set of digital rights includes conditions, permissions, and relationships between the conditions and permissions. The example computer program code may also be configured to direct the apparatus to include the conditions of the set of digital rights in a pool of conditions, identify conditions that have relationships with more than one permission and create copies of the identified conditions based on the number of relationships an identified condition has with the permissions, include the copies of the conditions in the pool of conditions, associate each condition within the pool of conditions with a respective permission based on the relationships to generate fundamental condition-permission components, and construct a fundamental decomposition of the set of digital rights based on the fundamental condition-permission components.

Another example apparatus comprises means for performing various functionalities. In this regard, the apparatus may include means for receiving a set of digital rights, wherein the set of digital rights includes conditions, permissions, and relationships between the conditions and permissions. The example apparatus may further comprise means for including the conditions of the set of digital rights in a pool of conditions, means for identifying conditions that have relationships with more than one permission and create copies of the identified conditions based on the number of relationships an identified condition has with the permissions, means for including the copies of the conditions in the pool of conditions, means for associating each condition within the pool of conditions with a respective permission based on the relationships to generate fundamental condition-permission components, and means for constructing a fundamental decomposition of the set of digital rights based on the fundamental condition-permission components.

### BRIEF DESCRIPTION OF THE DRAWING(S)

Having thus described some example embodiments of the invention in general terms, reference will now be made to the accompanying drawings, which are not necessarily drawn to scale, and wherein:

FIG. 1 illustrates a block diagram of an apparatus and associated system for digital rights decomposition according to some example embodiments of the present invention;

FIG. 2 illustrates a block diagram of a terminal configured for digital rights decomposition according to some example embodiment of the present invention; and

FIG. 3 is a flow chart of an example method for digital rights decomposition according to an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

Various example embodiments of the present invention relate to methods, apparatuses, and computer program products for performing digital rights decomposition. According to various example embodiments, the decomposition of digital rights into to their most basic components can facilitate digital right management (DRM) interoperability by providing a foundation from with different in DRM formats may be considered, possibly for translation.

Digital rights may be used in a variety of contexts, and the number of platforms that utilize digital rights continues to grow as the demand for digital content services grows. For example, the digital content services domain, which can leverage the use of digit rights, includes digital television, e-newspaper subscriptions, real-time driving maps, gaming, music, and the like. Because of the increasing availability of digital content and the ease of copying and distributing content using modern technology, digital rights are becoming increasingly relied upon to protect the content and prevent misuse.

However, many DRM systems do not often interoperate with each other, which can lead to frustrations for both content providers and end users. Content providers may be forced to adapt their content for a variety of different DRM systems and formats to maintain the protected availability of their content. End users may also suffer from incompatibilities for content usage between devices or applications due to different DRM solutions. For example, an end user may purchase a music file for his mobile phone and play the music file on his mobile phone. However, the user may not be able to play the same music file on his personal computer or media player device, because the personal computer and media player device utilize different DRM systems. Incompatibility problems of this type can occur even between different versions of a DRM system that relies on the same DRM standard.

As such, some example embodiments of the present invention improve the prospects of DRM interoperability by overcoming obstacles that exist due to the differences between the various DRM systems by decomposing digital rights into the fundamental building blocks of digital rights for the purpose of facilitating digital rights interoperability. In this regard, a digital right, which may be part of a set of rights, may be comprised of a number of conditions and associated permissions. Permissions may define the type of usage allowed for content under the protection of the rights. In this regard, a user or device may have the right to playback a digital video if certain conditions are met, thereby resulting in the permission to use the right, that is, playback the digital video. According to some example embodiments, a permission may comprise two attributes. The attributes may be a permission type and a content identifier (ID). The permission type may classify the instance or operation that is permitted, such as to play, view, or print the content. The content ID may be an identifier of the content for which the instances of permission is granted.

Any number of conditions, which may also be in the form of constraints, obligations or agreements, may need to be met before a permission may be granted. A condition may include the information that the permission must obey before a user is able to gain some type of the access to the content. In some instances, the condition may be true or false based on various attribute of the condition. The attributes of a condition may include the condition type and the condition detail.

The condition type may classify the instance of condition, with, for example, a count, an end time, or a specified period. Condition types can separate conditions into stateful conditions and stateless conditions. A stateful condition may have a dynamic internal state to determine the condition's validity. The internal state may be changed based on, for example, the end user's action. In this regard, a count-based condition may be a stateful condition. The internal state of a count-based condition may be the number of the count. When the instance of permission that links to the condition is granted once, the number of the count, for example, may be decremented. When the number of the count becomes zero, the condition may become false. On the other hand, a stateless condition may be a condition that has no dynamic internal state, which can be changed, for example, by a user's action, to determine its validity. In this regard, an end time-based condition may be a stateless condition. The validity of an end time-based condition may be determined only by the time after which the end user's action should not have an influence.

A condition detail may describe the instance of a condition according to the condition type. Examples of condition details may be a number for a count-based condition and a specific time for a time-based condition.

Further, according to some example embodiments, satisfying a particular condition may be necessary to obtain different permissions. For example, a time-based condition may need to be satisfied in order for a user to be permitted to view and print content. As such, some permissions may share a particular condition.

Common attributes for relationship or linkages between conditions and permissions include an instance of permission, an instance of a condition, and a type of linkage. The type of linkage may allow for future extensions of other types of linkage. An instance of permission may link to more than one instance of condition, while an instance of condition could also link to more than one instance of permission. However, if there is no instance of condition linked to the instance of permission, the instance of permission may be granted without any restriction from the DRM system. Conversely, an instance of condition may link to at least one instance of permission.

The relationship or linkage between a permission and a condition may be expressed by two types of virtual paths: a validity-checking path and an influential path. In a validity-checking path, the linkage may be the virtual path which a DRM system follows when checking the validities of instances of a condition in order to grant an instance of a permission. Before a DRM system grants an instance of a permission to the end user, the system may check the validity of some or all the instances of the conditions linked to the instance of the permission. If the instances of the conditions are satisfied, the DRM system may then grant the permission. The linkages between permissions and conditions may lead the DRM system on a virtual path to check the validities, where the validity-checking paths represent how conditions restrict permissions.

An influential path may only exist between a permission and a stateful condition. An influential path may occur when updating the internal state of a stateful condition. If the instance of a permission links to some instances of some stateful conditions, the internal states for the linked instances of the stateful conditions can be updated by the DRM system once the permission is granted. The influential paths may represent how permissions influence conditions.

The two kinds of paths, together, can represent the interaction and relationship between permissions and conditions. However, according to some example embodiments, a linkage does not necessarily include two paths. If the instance of condition is a stateless condition, according to some example embodiments, only the validity-checking path may exist in the linkage between the instance of condition and the instance of permission. If the instance of condition is a stateful condition, there may be three possibilities for a linkage between an instance of permission and the instance of condition: validity-checking path only, influential path only, and both paths.

In this regard, suppose an end user named Jack has an instance of a permission to play a game and an instance of a condition that is “10 times”. If the linkage between the permission and the condition is a validity-checking path, according to some example embodiments, then the count will not decrease when Jack plays the game. However, if the count is decreased to zero by another linked instance of permission, Jack may not be able to play the game again. If the linkage is an influential path only, according to some example embodiments, then the count may be decremented if Jack plays the game once. However, if the count is decreased to zero, according to some example embodiments, then Jack may still be able to play the game. If the linkage is both a validity-checking path and an influential path, according to some example embodiments, then the count may decrease when Jack plays once, and when the count is decreased to zero, Jack may not be able to play anymore.

With these rights as a mechanism to protect content, various approaches may be considered to implement digital rights interoperability. In this regard, example techniques for implementing digital rights interoperability may include full format interoperability, configuration-driven interoperability, or connected interoperability.

Full format interoperability can involve all participants (e.g., creators, distributors, manufactures, and the like) using the same digital rights management system. In this regard, the same data representation, encoding, protection scheme, trust management, key management, and the like may be utilized. Since this can result in their being a single standard system for digital rights, interoperability may no longer be an issue if full format interoperability could be achieved. However, full format interoperability may not be a practical solution in the short term due to the requirement of consolidating among all existing standards and the effort to build a standard that covers all the requirements that come from various rights systems.

Configuration-driven interoperability involves the installation of tools on a platform to support the various configurations of DRM systems. Configuration-driven interoperability may be suitable for solutions between two specific systems, since it may force the target DRM systems to change through the installation of tools. In this regard, tools may be downloaded to the importing device, and configured in real time in order to use protected content from other DRM systems. When dealing with interoperability between many systems, configuration-driven interoperability may be limited, in that installations are required on many, if not all, of the DRM systems concerned. Also, tool installation can raise the potential risk of security compromise.

Connected interoperability can centralize the effort of interoperability among DRM systems by providing a mechanism and entity that translates content and rights from one DRM system to another. In some instances, this translation may be provided by a third-party online service. However, connected interoperability can require connections and coordination between the service providers of interoperability and the targeted DRM systems.

Intermediary DRM interoperability, which is a type of connected interoperability, can implement content and rights reformatting, data management, condition evaluation, and dynamic state evaluation. Content and rights reformatting may be performed since the formats for both content and rights may be well defined in DRM specifications. Data management may require storage and access control for rights-related information, and may ensure the security and reliability of data flow. In some instances, data management may be required for rights purchases on some DRM systems. Further, condition evaluation can involve checks of the feasibility of rights flow among different DRM systems, and dynamical state evaluation can involve the evaluation of rights on behalf of the end user's device. While, in some instances, reformatting and data management may be readily performed, condition evaluation and dynamical state evaluation may be more complex and may be in need of a particular approach to facilitate DRM interoperability and translation.

Further, translations of digital rights may be categorized into at least three categories. The categories may include isomorphism, in which the translation of rights from one DRM system to another may be exactly equivalent; adaptation, in which rights from one DRM system may be modified in order to suit the requirements of another DRM system; and untranslatable expressions, whereby some expressions in rights cannot be translated from one DRM system to another. According to some example embodiments, the translation of rights, as part of, or subsequent to, a decomposition of rights, may involve consideration of the formal semantics used to represent the right via a rights expression language (REL). These semantics may range from logic-based and automata-based semantics to abstract right model and LicenseScript.

In consideration of the above, some example embodiments of the present invention operate to decompose digital rights of any type to their most fundamental building blocks in order to facilitate DRM interoperability. By decomposing digital rights, equivalent sets of instances of rights that cannot be further decomposed may be created. To perform the decomposition, the conditions, permissions, and relationships between the conditions and permissions included in a digital right may be considered and decomposed. In this regard, according to various example embodiments, each condition (e.g., stateless condition) that is shared with more than one permission may be copied to avoid sharing the same instance of the condition in the decomposed form the digital right. According to some example embodiments, a stateful condition cannot be copied and used because the internal state of the stateful condition may be erroneous or lead to an erroneous value for the original or copied stateful condition. After copying the shared conditions, the original and copied conditions may be considered with the permissions in view of the direct or indirect relationships or linkages that were described in the original digital right. In this regard, the conditions and permissions can be associated to generate fundamental condition-permission components of the digital right that cannot be further decomposed. These fundamental condition-permission components may be considered together, possibly in the form of a graph, to represent a fundamental decomposition of the digital right or a set of digital rights.

In this regard, the following provides an example method and algorithm for decomposing digital rights. The input to the example method may be a set of instances of rights to be decomposed, and the output may be a set of sets of instances of rights (e.g., fundamental condition-permission components), each of which, for example, cannot be further decomposed.

The example method may include receiving, or otherwise obtaining, a set of digital rights, where the rights include conditions, permissions, and relationships between the conditions and permissions defined within the digital rights. The conditions of the rights may be first extracted or considered part of a pool of conditions. The conditions may also be analyzed to determine if there are conditions that are shared by any permissions. In this regard, if there exist any conditions C (e.g., stateless conditions) shared by permissions P₁, P₂. . . , Pₙ, then copies of the conditions may be created C₁, C₂, . . . , Cₙ, of the condition C. These copies may then be included in the pool of conditions. As such, based on the conditions in the pool, each permission can be described with respect to the conditions without having to share a condition with any other permission, due to the presence of the copies in the pool. As such, for each permission Pᵢ (i=1, . . . , n), C may be replaced by Cᵢ as a condition for that permission. In this regard, each condition within the pool may be associated with a respective permission based on the relationships defined for the digital right to generate fundamental condition-permission components. According to some example embodiments, a fundamental condition-permission component of the digital rights may include at least one condition and only one permission.

The fundamental condition-permission components may be used to construct a fundament decomposition of the set of digital rights. In this regard, a graph G may be constructed, where the nodes of G may be the conditions and permissions of the set of rights and taken from the fundamental condition-permission components, and the edges of G may be the relationships or linkages between conditions and permissions. Accordingly, from each connected component of G, or from each fundamental condition-permission component, an output set of rights may be derived.

According to various example embodiments, the decomposition of the digital rights may be performed in accordance with a format of the particular set of rights as indicated by the right expression language (REL) of the set of rights. In this regard, the REL of the set of rights may be determined, possibly based on storage attributes of the digital rights. Further, based on the determination of the REL for the digital rights, a particular format may be considered when performing the decomposition.

The decomposition as described herein may be performed in a variety of cases throughout the life of the digital rights. In a first case, the decomposition may be performed when a device imports an instance of the digital rights from a rights issuer and/or when the rights issuer issues the instance of the digital rights to the device. In a second case, the decomposition may be performed, depending on the deployment of DRM system on the device, on-demand after the set of digital rights has been stored on the device and if the decomposition could further optimize the rights validation process on the device. Additionally, in a third case, decomposition may be performed prior to the device exporting an instance of the rights to another device. Further, in a fourth case, the decomposition may be performed when the device is importing an instance of digital rights from another device. Finally, in a fifth case, decomposition may be performed if the instance of digital rights is mandated by a third party service (e.g., possibly in accordance with connected interoperability). In this regard, the third party DRM system or entity (e.g., network server) may decompose the instance of digital rights after the right issuer has issued the digital rights to the third party service.

Further, depending on the cases, decomposition may be placed in different scenarios. In this regard, in the first and fifth cases described above, the rights issuer may utilize the REL (rights expression language) as the format to issue an instance of the digital rights to a DRM system. Therefore, the decomposition may be performed by analyzing the syntax of the REL and producing the corresponding procedure. Otherwise, the decomposition may be performed after the instance of the digital rights has been stored on the domestic or local DRM system in a particular the format for internal storage. In the second, third and fourth cases, the format of the instance or set of digital rights stored may be determined by the DRM system on the device, and therefore the decomposition may be performed according to the manner of the internal storage of the domestic or local DRM system, which may vary for different DRM systems. As such, according to various example embodiments, implementation of the example method or algorithm may be based on the REL of the digital rights, which may be known or determined from the internal storage the DRM system.

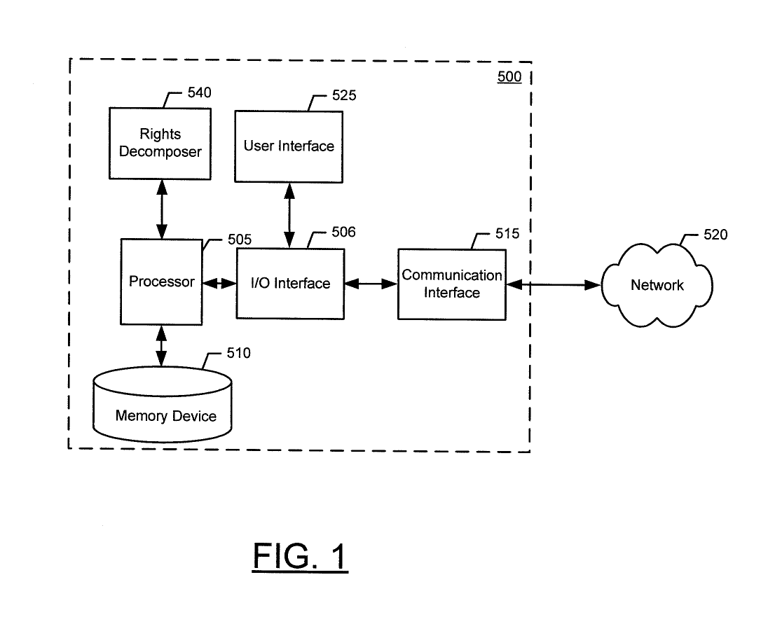

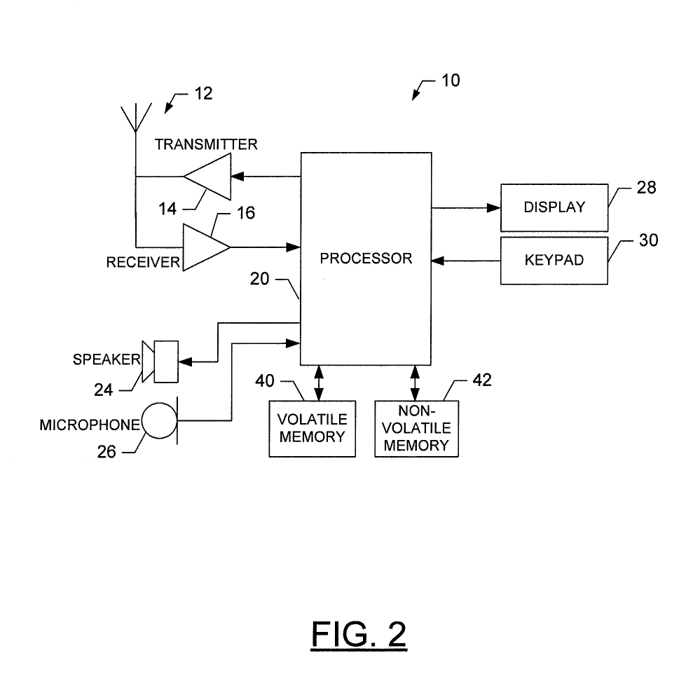

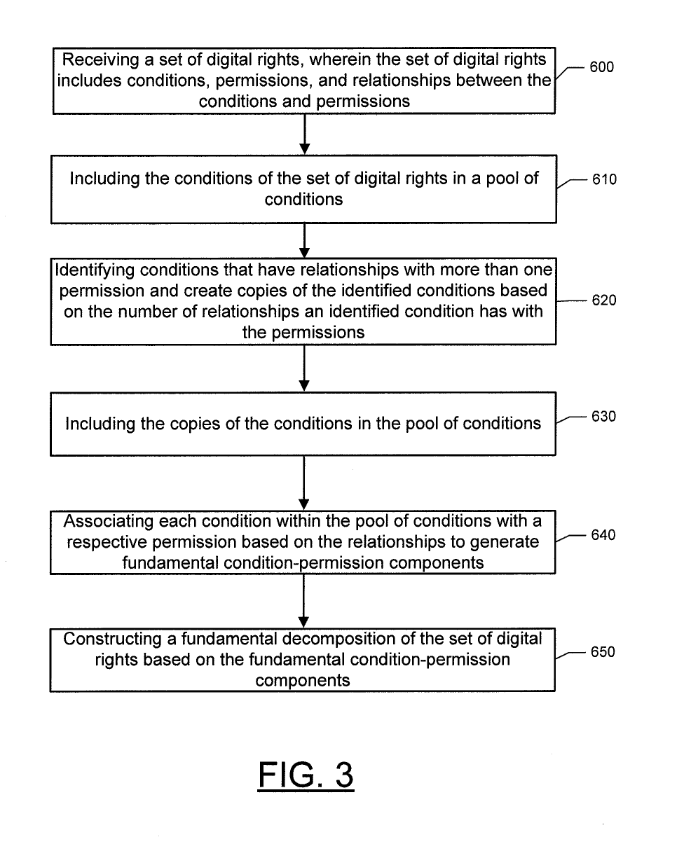

The description provided above and generally herein illustrates example methods, example apparatuses, and example computer program products for decomposing digital rights. FIGS. 1 and 2 depict example apparatuses that may be configured to perform various functionalities as described herein, including those described with respect to the description provided above, with respect to the flowchart of FIG. 3, and the operations and functionality otherwise described herein.

Referring now to FIG. 1, an example embodiment of the present invention is depicted as apparatus 500. In some example embodiments, the apparatus 500 may, be embodied as, or included as a component of, an electronic computing device. Apparatus 500 may or may not be configured to perform wired and/or wireless communications. In some example embodiments, the apparatus 500 may be part of a device, such as a stationary or a mobile communications terminal. As a mobile device, the apparatus 500 may be a mobile and/or wireless communications node such as, for example, a computer, a server, an access point, a handheld wireless device (e.g., telephone, smart phone, portable digital assistant (PDA), mobile television, digital book reader, tablet device, gaming device, camera, video recorder, audio/video player (e.g., CD/DVD player), radio, and/or a global positioning system (GPS) device), any combination of the aforementioned, or the like.

FIG. 1 illustrates a block diagram of example components of the apparatus 500. The example apparatus 500 comprises or is otherwise in communication with a processor 505, a memory device 510, an Input/Output (I/O) interface 506, and a rights decomposer 540. In some example embodiments, the apparatus 500 also includes a user interface 525, and a communications interface 515. The processor 505 may, according to some example embodiments, be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 505 may be representative of a plurality of processors, or one or more multiple core processors, operating in concert. Further, the processor 505 may be comprised of a plurality of transistors, logic gates, a clock (e.g., oscillator), other circuitry, and the like to facilitate performance of the functionality described herein. The processor 505 may, but need not, include one or more accompanying digital signal processors. In some example embodiments, the processor 505 is configured to execute instructions stored in the memory device 510 or instructions otherwise accessible to the processor 505. The processor 505 may be configured to operate such that the processor causes or directs the apparatus 500 to perform various functionalities described herein.

Whether configured as hardware or via instructions stored on a computer-readable storage medium, or by a combination thereof, the processor 505 may be an entity and means capable of performing operations according to embodiments of the present invention while configured accordingly. Thus, in example embodiments where the processor 505 is embodied as, or is part of, an ASIC, FPGA, or the like, the processor 505 is specifically configured hardware for conducting the operations described herein. Alternatively, in example embodiments where the processor 505 is embodied as an executor of instructions stored on a computer-readable storage medium, the instructions specifically configure the processor 505 to perform the algorithms and operations described herein. In some example embodiments, the processor 505 is a processor of a specific device (e.g., a communications server or mobile device) configured for employing example embodiments of the present invention by further configuration of the processor 505 via executed instructions for performing the algorithms, methods, and operations described herein.

The memory device 510 may be one or more tangible and/or non-transitory computer-readable storage media that may include volatile and/or non-volatile memory. In some example embodiments, the memory device 510 comprises Random Access Memory (RAM) including dynamic and/or static RAM, on-chip or off-chip cache memory, and/or the like. Further, memory device 510 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 510 may include a cache area for temporary storage of data. In this regard, some or all of memory device 510 may be included within the processor 505. In some example embodiments, the memory device 510 may be in communication with the processor 505 and/or other components via a shared bus.

Further, the memory device 510 may be configured to store information, data, applications, computer-readable program code instructions, and/or the like for enabling the processor 505 and the example apparatus 500 to carry out various functions in accordance with example embodiments of the present invention described herein. For example, the memory device 510 may be configured to buffer input data for processing by the processor 505. Additionally, or alternatively, the memory device 510 may be configured to store instructions for execution by the processor 505.

The I/O interface 506 may be any device, circuitry, or means embodied in hardware, software, or a combination of hardware and software that is configured to interface the processor 505 with other circuitry or devices, such as the communications interface 515. In some example embodiments, the I/O interface may embody or be in communication with a bus that is shared by multiple components. In some example embodiments, the processor 505 may interface with the memory 510 via the I/O interface 506. The I/O interface 506 may be configured to convert signals and data into a form that may be interpreted by the processor 505. The I/O interface 506 may also perform buffering of inputs and outputs to support the operation of the processor 505. According to some example embodiments, the processor 505 and the I/O interface 506 may be combined onto a single chip or integrated circuit configured to perform, or cause the apparatus 500 to perform, various functionalities of the present invention.

In some embodiments, the apparatus 500 or some of the components of apparatus 500 (e.g., the processor 505 and the memory device 510) may be embodied as a chip or chip set. In other words, the apparatus 500 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 500, or particular components of the apparatus 500, may therefore, in some cases, be configured to implement embodiments of the present invention on a single chip or as a single “system on a chip.” As such, in some cases, a chip or chipset may constitute means for performing the functionalities described herein and with respect to the processor 505.

The communication interface 515 may be any device or means embodied in hardware, a computer program product, or a combination of hardware and a computer program product that is configured to receive and/or transmit data from/to a network 520 and/or any other device or module in communication with the example apparatus 500.

The communications interface may be configured to communicate information via any type of wired or wireless connection, and via any type of communications protocol, such as a communications protocol that supports cellular communications. According to various example embodiments, the communication interface 515 may be configured to support the transmission and reception of communications in a variety of networks including, but not limited to Internet Protocol-based networks (e.g., the Internet), cellular networks, or the like. Further, the communications interface 515 may be configured to support device-to-device communications. Processor 505 may also be configured to facilitate communications via the communications interface 515 by, for example, controlling hardware included within the communications interface 515. In this regard, the communication interface 515 may include, for example, communications driver circuitry (e.g., circuitry that supports wired communications via, for example, fiber optic connections), one or more antennas, a transmitter, a receiver, a transceiver and/or supporting hardware, including, for example, a processor for enabling communications. Via the communication interface 515, the example apparatus 500 may communicate with various other network entities in a device-to-device fashion and/or via indirect communications via a base station, access point, server, gateway, router, or the like.

The user interface 525 may be in communication with the processor 505 to receive user input via the user interface 525 and/or to present output to a user as, for example, audible, visual, mechanical, or other output indications. The user interface 525 may include, for example, a keyboard, a mouse, a joystick, a display (e.g., a touch screen display), a microphone, a speaker, camera, accelerometer, or other input/output mechanisms. Further, the processor 505 may comprise, or be in communication with, user interface circuitry configured to control at least some functions of one or more elements of the user interface. The processor 505 and/or user interface circuitry may be configured to control one or more functions of one or more elements of the user interface through computer program instructions (e.g., software and/or firmware) stored on a memory accessible to the processor 505 (e.g., volatile memory, non-volatile memory, and/or the like). The user interface 525 may also be configured to support the implementation of haptic feedback. In this regard, the user interface 525, as controlled by processor 505, may include a vibra, a piezo, and/or an audio device configured for haptic feedback as described herein. In some example embodiments, the user interface circuitry is configured to facilitate user control of at least some functions of the apparatus 500 through the use of a display and configured to respond to user inputs. The processor 505 may also comprise, or be in communication with, display circuitry configured to display at least a portion of a user interface, the display and the display circuitry configured to facilitate user control of at least some functions of the apparatus 500.

The rights decomposer 540 of example apparatus 500 may be any means or device embodied, partially or wholly, in hardware, a computer program product, or a combination of hardware and a computer program product, such as processor 505 implementing stored instructions to configure the example apparatus 500, memory device 510 storing executable program code instructions configured to carry out the functions described herein, or a hardware configured processor 505 that is configured to carry out the functions of the rights decomposer 540 as described herein. In an example embodiment, the processor 505 comprises, or controls, the rights decomposer 540. The rights decomposer 540 may be, partially or wholly, embodied as processors similar to, but separate from processor 505. In this regard, the rights decomposer 540 may be in communication with the processor 505. In various example embodiments, the rights decomposer 540 may, partially or wholly, reside on differing apparatuses such that some or all of the functionality of the rights decomposer 540 may be performed by a first apparatus, and the remainder of the functionality of the rights decomposer 540 may be performed by one or more other apparatuses.

Further, the apparatus 500 and the processor 505 may be configured to perform the following functionality via rights decomposer 540 as well as other functionality described herein. The rights decomposer 540 may be configured to cause or direct means such as the processor 505 and/or the apparatus 500 to perform various functionalities, such as those described herein and as described with respect to the flowchart of FIG. 3.

For example, with reference to FIG. 3, the rights decomposer 540 may be configured to receive a set of digital rights at 600. In this regard, the set of digital rights may include conditions, permissions, and relationships between the conditions and permissions. The rights decomposer 540 may also be configured to include the conditions of the set of digital rights in a pool of conditions at 610, and identify conditions that have relationships with more than one permission and create copies of the identified conditions based on the number of relationships an identified condition has with the permissions at 620. Further, at 630, the rights decomposer 540 may be configured to include the copies of the conditions in the pool of conditions, and, at 640, associate each condition within the pool of conditions with a respective permission based on the relationships to generate fundamental condition-permission components. The rights decomposer 540 may also be configured to construct a fundamental decomposition of the set of digital rights based on the fundamental condition-permission components at 650.

According to some example embodiments, the rights decomposer 540 may be configured to construct the fundamental decomposition by generating a graph where the nodes of the graph are based on the conditions and permissions of fundamental condition-permission components and the edges of the graph are based on condition to permission associations of each fundamental condition-permission component. Additionally, or alternatively, according to some example embodiments, the rights decomposer 540 may be further configured to identify a right expression language (REL) of the set of digital rights, for example, based on storage attributes of the set of digital rights. In this regard, constructing the fundamental decomposition may be performed based on the identified REL of the set of digital rights. In some example embodiments, the rights decomposer 540 may additionally or alternatively be configured to translate the fundamental decomposition into a digital rights format that differs from a digital right format of the received set of digital rights. According to some example embodiments, the rights decomposer 540 may be configured to associate each condition within the pool of conditions with the respective permission based on the relationships to generate the fundamental condition-permission components, wherein each fundamental condition-permission component includes at least one condition and only one permission. Further, in some example embodiments, the apparatus may comprise a mobile electronic device configured to playback media content associated with the set of digital rights, and may further comprise a display configured to present the media content.

Referring now to FIG. 2, a more specific example apparatus in accordance with various embodiments of the present invention is provided. The example apparatus of FIG. 2 is a mobile terminal 10 configured to communicate within a wireless network, such as a cellular communications network. The mobile terminal 10 may be configured to perform the functionality of the apparatus 500 and the other functionalities described herein. More specifically, the mobile terminal 10 may be caused to perform the functionality described with respect to FIG. 3, via the processor 20. In this regard, according to some example embodiments, the processor 20 may be configured to perform the functionality described with respect to the rights decomposer 540. Processor 20 may be an integrated circuit or chip configured similar to the processor 505 together with, for example, the I/O interface 506. Further, volatile memory 40 and non-volatile memory 42 may be configured to support the operation of the processor 20 as computer readable storage media.

The mobile terminal 10 may also include an antenna 12, a transmitter 14, and a receiver 16, which may be included as parts of a communications interface of the mobile terminal 10. The speaker 24, the microphone 26, display 28 (which may be a touch screen display), and the keypad 30 may be included as parts of a user interface.

FIG. 3 illustrates flowcharts and/or processes associated with example systems, methods, and/or computer program products according to example embodiments of the invention. It will be understood that each operation, and/or combinations of operations, can be implemented by various means. Means for implementing the operations, combinations of the operations, or other functionality of example embodiments of the present invention described herein may include hardware, and/or a computer program product including a computer-readable storage medium (as opposed to a computer-readable transmission medium which describes a propagating signal) having one or more computer program code instructions, program instructions, or executable computer-readable program code instructions stored therein. In this regard, program code instructions for performing the operations and functions of FIG. 3 or otherwise described herein may be stored on a memory device, such as memory device 510, volatile memory 40, or volatile memory 42, of an example apparatus, such as example apparatus 500 or mobile terminal 10, and executed by a processor, such as the processor 505 or processor 20. As will be appreciated, any such program code instructions may be loaded onto a computer or other programmable apparatus (e.g., processor 505, memory device 510, or the like) from a computer-readable storage medium to produce a particular machine, such that the particular machine becomes a means for implementing the functions specified in the operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the operations.

Accordingly, execution of instructions associated with the operations of the flowchart by a processor, or storage of instructions associated with the blocks or operations in a computer-readable storage medium, support combinations of operations for performing the specified functions. It will also be understood that one or more operations, and combinations of blocks or operations, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
receiving a set of digital rights, wherein the set of digital rights includes conditions, permissions, and relationships between the conditions and permissions;
including the conditions of the set of digital rights in a pool of conditions;
identifying conditions that have relationships with more than one permission and create copies of the identified conditions based on the number of relationships an identified condition has with the permissions;
including the copies of the conditions in the pool of conditions;
associating each condition within the pool of conditions with a respective permission based on the relationships to generate fundamental condition-permission components; and
constructing, via a processor, a fundamental decomposition of the set of digital rights based on the fundamental condition-permission components.

2. The method of claim 1, wherein constructing the fundamental decomposition includes generating a graph where nodes of the graph are based on the conditions and permissions of the fundamental condition-permission components and edges of the graph are based on condition to permission associations of each fundamental condition-permission component.

3. The method of claim 1, further comprising identifying a right expression language (REL) of the set of digital rights; and wherein constructing the fundamental decomposition is performed based on the identified REL of the set of digital rights.

4. The method of claim 1, further comprising identifying a right expression language (REL) of the set of digital rights based on storage attributes of the set of digital rights; and wherein constructing the fundamental decomposition is performed based on the identified REL of the set of digital rights.

5. The method of claim 1, further comprising translating the fundamental decomposition into a digital rights format that differs from a digital right format of the received set of digital rights.

6. The method of claim 1, wherein associating each condition within the pool of conditions with the respective permission includes associating each condition within the pool of conditions with the respective permission based on the relationships to generate the fundamental condition-permission components, wherein each fundamental condition-permission component includes at least one condition and only one permission.

7. An apparatus comprising at least one processor and at least one memory including computer program code, the at least one memory and the computer program code configured to, with the at least one processor, direct the apparatus at least to:
receive a set of digital rights, wherein the set of digital rights includes conditions, permissions, and relationships between the conditions and permissions;
include the conditions of the set of digital rights in a pool of conditions;
identify conditions that have relationships with more than one permission and create copies of the identified conditions based on the number of relationships an identified condition has with the permissions;
include the copies of the conditions in the pool of conditions;
associate each condition within the pool of conditions with a respective permission based on the relationships to generate fundamental condition-permission components; and
construct a fundamental decomposition of the set of digital rights based on the fundamental condition-permission components.

8. The apparatus of claim 7, wherein the apparatus directed to construct the fundamental decomposition includes being directed to generate a graph where nodes of the graph are based on the conditions and permissions of the fundamental condition-permission components and the edges of the graph are based on condition to permission associations of each fundamental condition-permission component.

9. The apparatus of claim 7, wherein the apparatus is further configured to identify a right expression language (REL) of the set of digital rights; and wherein the apparatus directed to construct the fundamental decomposition includes being directed to construct the fundamental decomposition based on the identified REL of the set of digital rights.

10. The apparatus of claim 7, wherein the apparatus is further directed to identify a right expression language (REL) of the set of digital rights based on storage attributes of the set of digital rights; and wherein the apparatus directed to construct the fundamental decomposition includes being directed to construct the fundamental decomposition based on the identified REL of the set of digital rights.

11. The apparatus of claim 7, wherein the apparatus is further directed to translate the fundamental decomposition into a digital rights format that differs from a digital right format of the received set of digital rights.

12. The apparatus of claim 7, wherein the apparatus directed to associate each condition within the pool of conditions with the respective permission includes being directed to associate each condition within the pool of conditions with the respective permission based on the relationships to generate the fundamental condition-permission components, wherein each fundamental condition-permission component includes at least one condition and only one permission.

13. The apparatus of claim 7, wherein the apparatus comprises a mobile electronic device configured to playback media content associated with the set of digital rights.

14. The apparatus of claim 13, wherein the apparatus further comprises a display configured to present the media content.

15. A computer program product comprising a non-transitory memory having program code stored thereon, the program code configured to direct an apparatus to:
receive a set of digital rights, wherein the set of digital rights includes conditions, permissions, and relationships between the conditions and permissions;
include the conditions of the set of digital rights in a pool of conditions;
identify conditions that have relationships with more than one permission and create copies of the identified conditions based on the number of relationships an identified condition has with the permissions;
include the copies of the conditions in the pool of conditions;
associate each condition within the pool of conditions with a respective permission based on the relationships to generate fundamental condition-permission components; and
construct a fundamental decomposition of the set of digital rights based on the fundamental condition-permission components.

16. The computer program product of claim 15, wherein the computer program code configured to direct the apparatus to construct the fundamental decomposition includes being configured to direct the apparatus to generate a graph where nodes of the graph are based on the conditions and permissions of the fundamental condition-permission components and the edges of the graph are based on condition to permission associations of each fundamental condition-permission component.

17. The computer program product of claim 15, wherein the computer program code is further configured to direct the apparatus to identify a right expression language (REL) of the set of digital rights; and wherein the computer program code configured to construct the fundamental decomposition includes being configured to direct the apparatus to construct the fundamental decomposition based on the identified REL of the set of digital rights.

18. The computer program product of claim 15, wherein the computer program code is further configured to direct the apparatus to identify a right expression language (REL) of the set of digital rights based on storage attributes of the set of digital rights; and wherein the computer program code configured to direct the apparatus to construct the fundamental decomposition includes being configured to direct the apparatus to construct the fundamental decomposition based on the identified REL of the set of digital rights.

19. The computer program product of claim 15, wherein the computer program code is further configured to direct the apparatus to translate the fundamental decomposition into a digital rights format that differs from a digital right format of the received set of digital rights.

20. The computer program product of claim 15, wherein the computer program code configured to direct the apparatus to associate each condition within the pool of conditions with the respective permission includes being configured to direct the apparatus to associate each condition within the pool of conditions with the respective permission based on the relationships to generate the fundamental condition-permission components, wherein each fundamental condition-permission component includes at least one condition and only one permission.
